(19) United States
(12) Patent Application Publication
(10) Pub. No.: US 2026/0228015 A1
(43) Pub. Date: Aug. 6, 2026

(54) NONLINEAR PHYSICAL COMPUTING APPARATUS WITH PERSISTENT SPATIALLY DISTRIBUTED PARAMETER REDISTRIBUTION AND RESET-VERIFIED DYNAMIC CONVERGENCE KINETIC ACCELERATION

(71) Applicant: Anil Rami, MOUNDSVILLE, WV (US)

(72) Inventor: Anil Rami, MOUNDSVILLE, WV (US)

(21) Appl. No.: 19/547,362

(22) Filed: Feb. 23, 2026

(51) Int. Cl. G06F 9/4401; G06N 10/40

(52) U.S. Cl. CPC G06F 9/4401; G06N 10/40

(57) ABSTRACT

A physical computing apparatus is disclosed comprising a continuous nonlinear physical medium coupled to excitation, measurement, and reset interfaces. Application of an excitation pattern produces persistent spatial redistribution of at least one governing material parameter within the medium. Time-dependent nonlinear evolution of state variables toward a stabilization threshold occurs with a baseline convergence time under initial excitation. Reapplication of substantially identical excitation produces a measurably reduced convergence time due to the persistent redistribution. Operation of the reset interface substantially removes the redistribution and restores convergence kinetics to baseline.

### CROSS-REFERENCE TO RELATED APPLICATIONS

### CROSS-REFERENCE TO RELATED APPLICATIONS

This application claims the benefit of U.S. Provisional Patent Application No. 63/983,076 , filed Feb. 14, 2026, the entirety of which is incorporated herein by reference. This application is also related to U.S. patent application Ser. Nos. 19/455,843 and 19/452,222, which disclose subject matter in related technical fields. The present disclosure is structurally and operationally distinct from the subject matter of those applications.

### FIELD OF THE INVENTION

The invention relates to physical computing systems implemented in continuous nonlinear physical media in which excitation produces persistent spatial redistribution of governing material parameters that measurably alters subsequent dynamic nonlinear evolution kinetics.

### BACKGROUND OF THE INVENTION

Physical computing systems utilizing nonlinear materials are known, including photorefractive media, ionic conductors, magnetic materials, and superconducting systems.

Certain materials exhibit persistent parameter modification after excitation. However, prior systems do not require verification that:
(1) A defined excitation produces a measurable baseline convergence time associated with dynamic nonlinear evolution of the medium;
(2) Reapplication of substantially identical excitation produces measurably reduced convergence time; and
(3) Removal of the persistent redistribution restores convergence kinetics to baseline under identical excitation conditions.

There remains a need for a physical computing apparatus in which persistent spatial redistribution of a governing material parameter produces reset-verified acceleration of dynamic nonlinear evolution toward stabilization.

### SUMMARY OF THE INVENTION

The present invention provides a physical computing apparatus comprising a continuous nonlinear physical medium, at least one excitation interface, at least one measurement interface, and at least one reset mechanism. The apparatus is configured to utilize intrinsic nonlinear physical dynamics of the medium, wherein an initial excitation pattern produces a persistent spatial redistribution of at least one governing material parameter. Unlike traditional computing architectures, the apparatus lacks independently addressable memory cells and programmable weight matrices.

A primary feature of the invention is reset-verified kinetic acceleration. The measurement interface measures baseline convergence time—the duration required for time-dependent nonlinear evolution of the medium's state variables to reach a predefined stabilization threshold under a first excitation. Subsequent application of a substantially identical excitation pattern produces a measurably reduced convergence time due to the influence of persistent spatial redistribution on the medium's evolution kinetics.

The reset mechanism substantially removes the persistent spatial redistribution. Operation of the reset restores the medium such that reapplication of the excitation produces a convergence time substantially equal to the original baseline, thereby verifying that the convergence kinetic acceleration arises from the persistent spatial redistribution rather than irreversible material change or global thermal variation.

### DETAILED DESCRIPTION OF THE INVENTION

The apparatus includes a physically continuous nonlinear material domain in which internal state variables evolve over time under nonlinear physical interaction laws.

Excitation is applied via at least one excitation interface.

Excitation produces persistent spatial redistribution of governing material parameters including refractive index, electrical conductivity, ionic mobility, magnetic anisotropy, superconducting phase stiffness, or strain distribution.

Persistent redistribution persists beyond cessation of excitation and alters subsequent nonlinear evolution kinetics.

Convergence refers to time-dependent nonlinear evolution toward a predefined stabilization threshold.

A stabilization threshold may be defined by magnitude of state change falling below a predefined tolerance or entry of an output parameter into a defined tolerance band.

Baseline convergence time refers to time required to reach stabilization during initial excitation.

Reset substantially removes persistent redistribution and restores convergence kinetics to baseline.

1. A physical computing apparatus comprising: a continuous nonlinear physical medium; at least one excitation interface configured to apply a defined excitation pattern; at least one measurement interface configured to measure time required for time-dependent nonlinear evolution of state variables to reach a stabilization threshold; and a reset mechanism configured to substantially remove persistent spatial redistribution of at least one governing material parameter; wherein reapplication of substantially identical excitation following persistent redistribution produces a measurably reduced convergence time relative to baseline, and reapplication following reset produces a convergence time substantially equal to baseline under substantially identical excitation conditions.

2. A method of physical computation comprising applying excitation, measuring baseline convergence time, reapplying excitation following persistent redistribution, measuring reduced convergence time, performing reset, and verifying restoration of baseline convergence time.
